(19) United States
(12) Patent Application Publication
(10) Pub. No.: US 2023/0252137 A1
(43) Pub. Date: Aug. 10, 2023

(54) METHOD AND APPARATUS TO DETECT AND MANAGE ABERRANT USE OF A SOFTWARE SIGNING, ENCRYPTION AND OBFUSCATION SYSTEM

(71) Applicant: ARRIS Enterprises LLC, Suwanee, GA (US)

(72) Inventors: Ting YAO, San Diego, CA (US); Xin QIU, San Diego, CA (US)

(73) Assignee: ARRIS Enterprises LLC, Suwanee, GA (US)

(21) Appl. No.: 18/106,411

(22) Filed: Feb. 6, 2023

Related U.S. Application Data
(60) Provisional application No. 63/307,355, filed on Feb. 7, 2022.

(51) Int. Cl. G06F 21/55; G06F 21/60

(52) U.S. Cl. CPC G06F 21/554; G06F 21/604; G06F 21/552

(57) ABSTRACT

A system and method for detecting and managing aberrant use of a remote data signing, encryption and obfuscation utility is disclosed. In one embodiment, the method comprises generating a first account activity characteristic pattern associated with the account, the first account activity characteristic pattern generated from execution of one or more first activities associated with the account occurring over a first temporal period, generating a second account activity characteristic pattern, the second account activity characteristic pattern generated from execution of one or more second activities associated with the account occurring over a second temporal period, comparing the first account activity characteristic pattern and the second account characteristic activity pattern, and flagging the account for action according to the comparison.

### CROSS-REFERENCE TO RELATED APPLICATIONS

The present application claims priority to U.S. Provisional App. No 63/307,355 filed Feb. 7, 2022, the contents of which are incorporated herein by reference in their entirety.

### BACKGROUND

### 1. Field

The present invention relates to systems and methods for signing data for use on devices, and in particular to a system and method for detecting and managing aberrant use of data signing services.

### 2. Description of the Related Art

It is beneficial in some circumstances to provide data to devices which have already been distributed to end users (e.g. fielded devices). Such data may be needed to update the device(s) to newer configurations or to perform additional functions, to ameliorate software “bugs” or other issues, or to simply replace data already resident in the device that may have been compromised. Such data may include software instructions (e.g. code) update fielded devices by providing data such as software code to those devices remotely.

One of the problems with the remote downloading of such data to fielded devices is that the data may be from an unauthorized source. An entity providing the data to the fielded devices may pose as a legitimate source of the data, yet provide data that is designed to compromise the security or functionality of the device. For example, the user of the device may be misled into believing that their device needs a software update in order to function properly, and may be provided a bogus uniform resource location (URL) from which to download the software update. If the user downloads and installs the software update from the bogus URL, the code that is actually downloaded may include a virus or other malware that negatively affects the operation of the device, perhaps compromising all of the data (including the user's private information) that was stored by the device before the infected.

To prevent the foregoing problems, code signing techniques can be used to digitally sign data such as executables and scripts. Such signatures confirm the identity of the author of the data and guarantee that the data has not been altered or otherwise corrupted since it was signed. Most code signing paradigms provide a digital signature mechanism to verify the identity of the author of the data or build system, and a checksum to verify that the data object has not been modified. Such code signing paradigms typically use authentication mechanisms such as public key infrastructure (PKI) technologies, which rely on data publishers securing their private keys against unauthorized access. The public key used to authenticate the data signature should be traceable back to a trusted root certificate authority (CA). If the data signature is traced to a CA that the device user trusts, the user is presumed to be able to trust the legitimacy and authorship of the data that is signed with a key generated by that CA.

Systems for code signing are known in the art. However, such systems do not provide a framework that allows different organizations or companies to structure their data signing permission needs as they see fit or to safely permit data signing by other independent organizations. For example, assume Company A produces a set top box that can use a chip that can execute software from Company 1 or Company 2. Company A may desire to establish a data signing framework that allows Company 1 to sign data that it installs into their set top boxes, without providing Company 2 with access to that data signing framework. Similarly, Company A may desire to establish a data signing framework that allows Company 2 to establish a data signing framework that excludes (or includes) Company 1. Systems for achieving this result are known, for example, as disclosed in U.S. Pat. No. 10,341,360 (hereby incorporated by reference) which discloses a system and method that provides management of code signing services by generic entities. Such systems may involve human interaction (e.g. a user physically commands) or may be completed automatically and without human interaction via software.

While online code signing systems are useful in preventing the installation of malware on devices, they are also subject to abuse. For example, if a hacker were somehow able to access the code signing system (for example, by subversion of an individual given permissions to sign code), the protections offered by the code signing system may be compromised. Further, online code signing systems typically provide code-signing services on a fee basis, and aberrant use of such systems can negatively affect the collection of such fees. For example, some fee models charge different amounts for signing code based on whether the code signing is performed human-in-the-loop or performed by a machine user running a script. If a subscriber to the data signing service had a human-in-the-loop subscription, but shared their credentials for signing the data with other individuals, the subscriber could ostensibly allow two individuals to use the same subscription, rather than purchase two subscriptions. Further, by sharing the subscription, the possibility of compromise is thereby increased.

### SUMMARY

To address the requirements described above, this document discloses a system and method for detecting and managing aberrant use of a remote data signing utility. In one embodiment, the method comprises generating a first account activity characteristic pattern associated with the account, the first account activity characteristic pattern generated from execution of one or more first activities associated with the account occurring over a first temporal period, generating a second account activity characteristic pattern, the second account activity characteristic pattern generated from execution of one or more second activities associated with the account occurring over a second temporal period, comparing the first account activity characteristic pattern and the second account characteristic activity pattern, and flagging the account for action according to the comparison.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram depicting one embodiment of an ODSS;

FIG. 2 is a diagram illustrating one embodiment of a manual process by which the designated users of the ODSS is used to sign data;

FIG. 3 is a diagram of an automated version of the ODSS;

FIG. 4 is a diagram depicting a hierarchical organization (e.g. hierarchy) of a plurality of entities associated with data signing operations;

FIG. 5 is a diagram depicting the hierarchical organization and the user roles associated with those entities;

FIG. 6 is a diagram of an ODSS that has been enhanced to scan for usage patterns, identify aberrant usage, and take appropriate actions when such aberrant usage is detected;

FIG. 7 is a diagram presenting exemplary method steps for generating a past activity pattern of a user account of the enhanced ODSS;

FIG. 8 is a diagram presenting exemplary operations for managing aberrant use of the enhanced ODSS to sign data; and

FIG. 9 illustrates an exemplary computer system that could be used to implement processing elements of the above disclosure.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

Described below are systems and methods useable in an online data signing system to detect and then prevent, reduce, or stop excessive use or abuse based on usage pattern, pre-configured usage quota, thus improving system security and preventing revenue loss.

These systems and methods are disclosed in use with an online data signing system that supports standard code signing formats such as PKCS#1, PKCS#7, and other proprietary signing mechanisms. The system can also perform activities such as data encryption and decryption or data obfuscation. Although the online data signing system can be used to sign any data, it is often used to sign code that is installed on remote devices. For purposes of discussion, we hereinafter refer to this system as an online code signing system (ODSS), recognizing that the system described is not limited to signing code, but can be used to sign any data.

The ODSS offers a web portal for users to login and sign code images or other types of digital objects, generate digital signatures, encrypt code, and/or decrypt code manually and a web service interface for machine clients to do so programmatically. In order to provide such an automatic mechanism to sign code, a machine-to-machine interface is provided over Internet such that the Client/User machine can automatically connect with the ODSS to request code signing. The ODSS utilizes an architecture which consists of a client application, an ODSS frontend (front-end server), and an ODSS backend (back-end server).

### Data Signing System

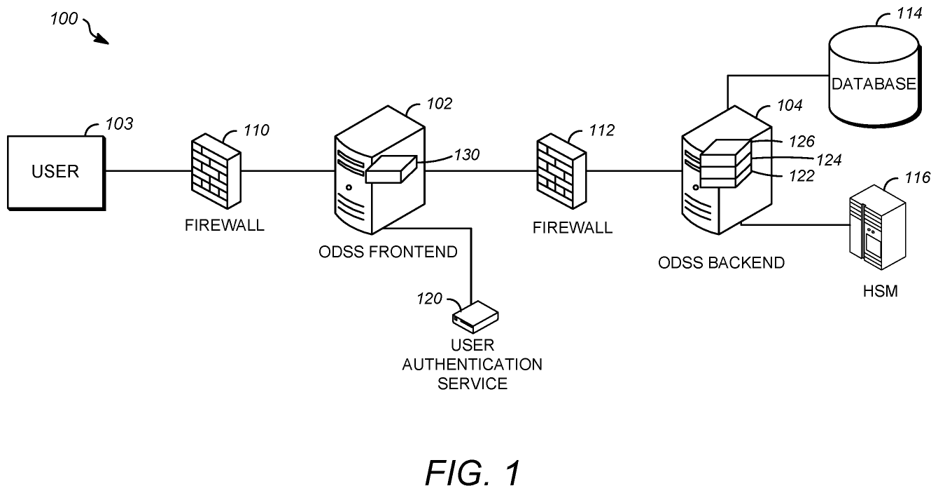

FIG. 1 is a diagram depicting an exemplary ODSS 100. The ODSS frontend 102 is a Graphic User Interface (GUI) layer that is the presentation layer for the ODSS 100. The ODSS frontend 102 is hosted on a server that is behind a firewall 110 to protect against unnecessary or unauthorized access. The ODSS frontend 102 comprises a web portal interface 130 that implements the presentation (e.g. “look and feel”) of functionality of the ODSS 100 to the user 103.

As described below, users 103 may include human users 103H, which comprise a human or person 106 (using a computer or other device not shown in FIG. 1) or a machine user 103M. Hereinafter, the term user 103 is used to refer collectively to either a human user 103H or a machine user 103M.

Preferably, the ODSS frontend 102 does not enforce signing permissions, perform any signing or key generation activities, or define the hierarchy of the entities discussed below or how the access to such entities are managed. Rather, the ODSS frontend 102 controls access to the ODSS backend 104, and the ODSS backend 104 performs the functionality of enforcing signing permissions, performing signing or key generation activities, and/or defining the hierarchy of the entities discussed below and how the access to such entities are managed.

The ODSS frontend 102 also has access to a server operating according to a user authentication service such as an Lightweight Directory Access Protocol (LDAP) server to authenticate valid users 103. The ODSS 100 maintains its own database of user 103 accounts, and the ODSS User authentication service 120 is used when a user 103 is added to the system for the first time and a user account is created and stored in the ODSS database 114.

To access the ODSS 100, the user 103 must specify user credentials, such as a password. Those credentials are used to validate every user session between the user 103 and the ODSS frontend 102. The ODSS 100 forbids access to users 103 unless valid credentials are provided and favorably compared to analogous information specified in ODSS database 114. Hence, only valid ODSS 100 users 103 having credentials matching those stored in the ODSS database 114) can access the ODSS 100.

The ODSS backend 104 is behind a second firewall 112 and provides protected access to the ODSS database 114 and the data signing keys that are stored in an ODSS hardware security module (HSM) 116. It is used to access the ODSS hierarchical entities discussed below and to look up user permissions for different data signing configurations and to perform all authorized crypto operations. The ODSS backend 104 connects to ODSS HSM 116 and using the ODSS HSM 116, performs operations such as data signing, encryption, decryption, and obfuscation. Obfuscation involves the transformation of a human-readable string into a string that is difficult to understand. Unlike encryption, it does not include a cryptographic key. The ODSS backend 104 may implement a plurality of software layers including, from the top software layer to the bottom software layer, an ODSS Service Layer 126, a Business Logic Layer (BLL) 122 and a Data Access Layer (DAL) 124.

Although the foregoing discloses an ODSS 100 having a ODSS frontend 102 and an ODSS backend 104, the ODSS 100 may be implemented with a single server performing the functions of both the ODSS frontend 102 and the ODSS backend 104, albeit, with reduced security.

The ODSS Service Layer 126 is the heart of ODSS 100 and is comprised of a plurality of signing/generation operations that are supported by ODSS 100. Depending on what type of service is needed, a specific dynamically loadable library (DLL) required for that service may be injected into memory to perform the operation.

The Business Logic Layer (BLL) 122 specifies which users 103 have access to the ODSS 100 and the conditions on which access is granted or revoked. The BLL 122 also takes care of other business logic such as updating audit logs and generating reports.

The Data Access Layer (DAL) layer 124 provides access to the ODSS database 114 and enables queries to access, add or remove entries in the ODSS database 114.

### Manual Interactive Web Processes

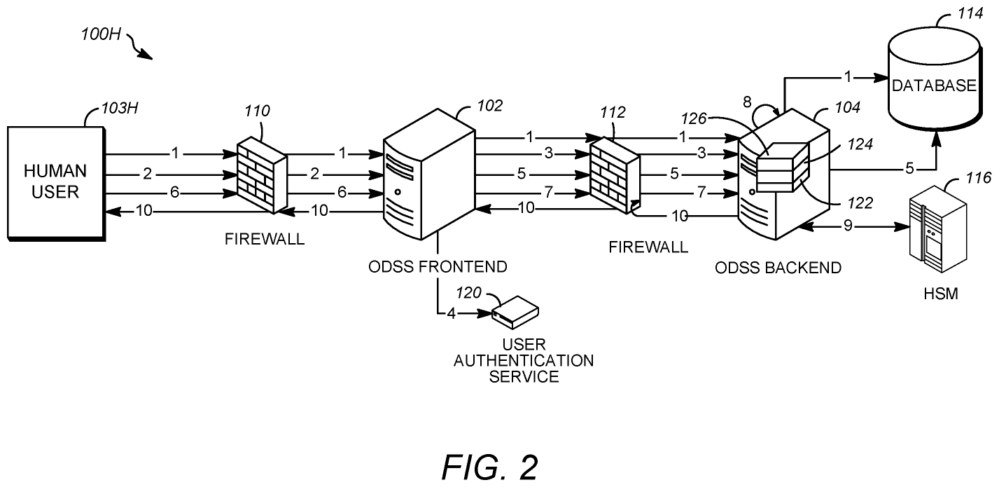

In a first embodiment, a manual data signing generation functionality is provided to users 103. This embodiment is illustrated in FIG. 2, which illustrates a human user ODSS 100H. This embodiment implements a manual process by which the designated human users 103H of the ODSS 100H sign data using a human user device 108H.

Step 1: In this embodiment, the user 103 is a human user 103H. Before a human user 103H can access the ODSS 100, an administrator—a person having an administrator role—of the ODSS 100 adds the user's identity such as a username to the ODSS configurations (further described below) in ODSS database 114 corresponding to software development projects the human user 103H has been assigned.

Step 2: The human user 103H interacts with the ODSS frontend 102 via a web browser executing on a computer. Preferably, this interaction is performed using the secure hypertext transfer protocol (HTTPS).

Step 3: The ODSS frontend 102 utilizes appropriate services provided by the ODSS backend 104 over a simple object access protocol (SOAP) interface.

Step 4: When the human user 103H logs in, the ODSS frontend 102 validates the received user credentials (e.g., username and password) against data stored in the ODSS User authentication service 120 and if the user credentials compare favorably with the data stored in the ODSS User authentication service 120, the human user 103H can access the ODSS 100. If not, the human user 103H is denied access to the ODSS 100.

Step 5: Based on logged in user's credential, the ODSS frontend 102 invokes BLL 122 of the ODSS backend 104 to look up user permissions to determine which configurations the logged in human user 103H has access to and presents only those configurations to the human user 103H.

Step 6: The human user 103H then selects one or more of the presented configurations and uploads an input/request file as well as other request parameters to ODSS frontend 102.

Step 7: The ODSS frontend 102 passes the uploaded input/request file, selected configuration, and operational details such as which signing key, signature algorithm, and/or digital signature format to use to ODSS backend 104.

Step 8: The ODSS backend 104, upon receiving request from the ODSS frontend 102, invokes the ODSS Service Layer 126.

Step 9: The invoked ODSS Service Layer 126 accesses the ODSS HSM 116 to get the keys that are needed to sign the data in the input/request file, and retrieves configuration details from ODSS database 114. In one embodiment, the ODSS Service Layer 126 also parses the input file. This is required because for some signing operations, the input file must follow a particular format, and this operation verifies that the input file is using the proper format, then retrieves certain information from certain portion(s) of input file. The ODSS Service Layer 126 then performs appropriate operations such as data signing, encryption, and decryption on the relevant portions of the input file. Based on these operations, the ODSS Service Layer 126 generates an output response file having the signed data and other information.

Step 10: The ODSS Service Layer 126 returns the generated output/response to the ODSS frontend 102. The ODSS frontend 102 generates a file from the generated output/response administrator client device, subsequently forwarded to the human user 103H.

### Automated Machine-to-Machine Interface

Another embodiment provides the automatic signing generation functionality to customers such that they can integrate this in their automated build process. In order to provide such a mechanism a machine-to-machine interface must be provided over Internet such that ODSS machine user client device 108M can automatically connect with our ODSS 100 Service to request data signing

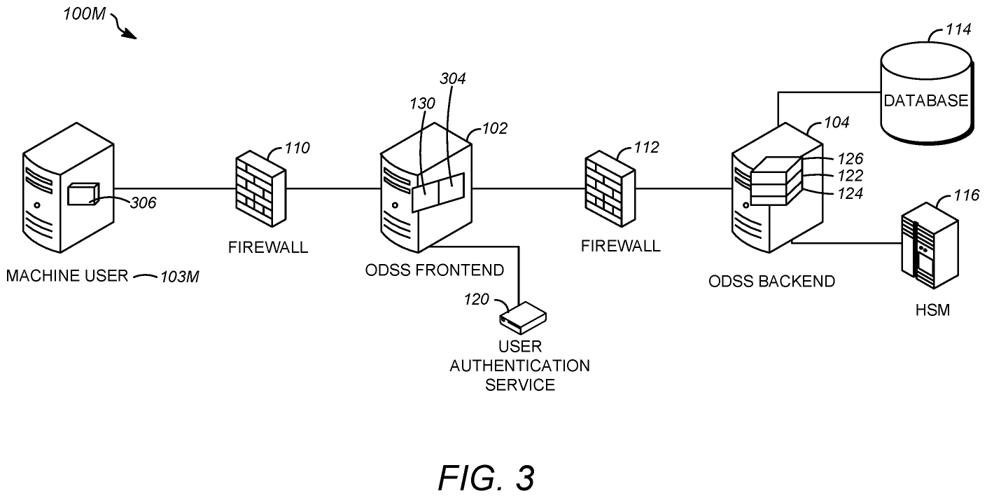

FIG. 3 is a diagram of an automated version of the ODSS 100M. As described below, the automated ODSS 100M uses same ODSS architecture depicted in FIG. 1, and can be used to support automated online requests from a ODSS machine user 103M implemented by a computer associated with an internet protocol (IP) address. In this case, the IP address is treated as a virtual user of the ODSS 100M and can obtain the same kinds of permissions as are normally assigned to a human user 103H.

The automated ODSS 100M introduces two additional components: an ODSS client tool 306 implemented on an ODSS machine user's computer and an ODSS web service 304. The ODSS Web Service 304 provides an interface to the ODSS 100 infrastructure elements described above.

The automated ODSS 100 implements a machine-to-machine interface that comprises ODSS client tool 306, ODSS Web Service 304 and ODSS backend 104. ODSS backend 104 functionality is shared between the manual user access modes described with respect to FIG. 2 (e.g. graphical user interface or GUI), and the machine-to-machine interface described further below.

### ODSS Client

The ODSS client tool 306 that is executed in the ODSS machine user 103M environment handles any pre-processing and post-processing of image files of the data to be signed so the ODSS machine user 103M does not need to know the details of the signing operations being performed on such data. The ODSS client tool 306 communicates with the ODSS Web Service 304 which runs on ODSS frontend 102.

### ODSS Web Service

The ODSS web service 304 is hosted on ODSS frontend 102 behind firewall 110 to protect against unauthorized access. The ODSS Web Service 304 performs authorization and authentication functionality of ODSS 100M. The ODSS web service 304 allows the ODSS machine user 103M, through the ODSS frontend 102 to request data signing, encryption and decryption without a human interface or human user 103H involvement.

### ODSS Machine-to-Machine Process

Before an ODSS machine user 103M can access ODSS 100, the ODSS administrator creates a user (machine) account in the ODSS User authentication service 120 and personalizes a hardware cryptographic token for that ODSS machine user 103M (by for example creating a digital certificate and private key on that token which identify a data signing client host where ODSS client tool 306 is executing). The hardware cryptographic token can be used for ODSS machine user device 108M authentication in a number of ways.

Once the ODSS machine user 103M is authenticated, the ODSS Web Service 304 invokes the ODSS backend 104 to retrieve machine authorization permission data that is used to determine whether the requesting machine account is authorized to perform the requested operation. Such authorization permission data is stored in the ODSS database 114.

Upon receiving the request from ODSS Web Service 304, the ODSS backend 104 invokes the ODSS Service Layer 126, which accesses the ODSS HSM 116 to retrieve the keys required for the data signing process and also retrieve configuration details for the configurations that the machine user 103M is authorized to access or control. The ODSS backend 104 then optionally parses the input file provided by the ODSS machine user 103M above. The ODSS backend 104 then performs the appropriate action such as signing the data or other data in the input file, and/or encryption and decryption of data or keys. Based on the results of the action, the ODSS Service Layer 126 generates a response having the output or results of the requested action. This output may comprise, for example, the signed data, and/or encrypted or decrypted keys. The ODSS Service Layer 126 later returns this output to ODSS Web Service 304 executing on the ODSS frontend 102. The ODSS Web Service 304 returns the generated output to ODSS client tool 306. If no output is available, the ODSS web service 304 returns an error code.

The ODSS 100M is secured with multiple layers of protection against unauthorized access and protection of private keys including those used to sign the data. Such protection includes:
ODSS machine user 103M authentication with a hardware crypto token. The hardware crypto token contains a certificate and a corresponding private key and is associated with a username and password. The private key may be used to decrypt a locally stored user password or for direct authentication to the ODSS.
Role-based and very flexible user authorization which allows for different roles including administrator, manager, or user. Machine users 103M can only be assigned a “user” role 506 as described below.
The ODSS backend 104 deployment in a secure area behind second firewall 112 which allows access to the ODSS backend 104 only from the ODSS frontend 102 ODSS.
Private keys are stored in ODSS HSM 116, and those keys cannot be retrieved in clear form. PKCS 11 is an example of a standards-based HSM interface which may be used for data signing, encryption, and decryption operations, thus never exposing the private keys in clear form.
Critical operations are checked against authorization rules (stored in the ODSS database 114) and performed only if they are permitted with those rules.

Certificates stored on hardware crypto tokens are generated with the IP address of the ODSS machine user 103M as a unique user identifier in the CommonName attribute of each certificate. Optionally, a client is not permitted to be behind proxy settings, so that the ODSS machine user 103M IP address is the actual address and not modified as seen by the server. IP addresses may be blocked from accessing ODSS 100 configurations and entities based on the geographic location associated with that IP address.

### Management of Users

As described above, there is a need to provide a framework that allows different organizations or companies to structure their data signing permission needs as they see fit or to safely permit data signing by other independent organizations that publish the data to their customers. This is accomplished by defining a hierarchical organization of a plurality of entities within the ODSS, and managing eligibility to designate users to access those entities via accounts granting different eligibility status, as further described below.

As described above, the ODSS system 100 has two types of users 103: human users 103H and machine users 103M. To manage those users, we define what “roles” can be assigned to these users. Such roles include administrator roles 502, manager roles 504, and user roles 508. Both human users 103H and machine users 103M may have “user” roles 508 in the ODSS system 100, while only human users 103H can have “manager” or “administrator” roles. In the following description, an entity (whether a human user 103H or a machine user 103H) that has the user role 508 is referred to as a transactional user 103T. A transactional user 103T is an entity that requests the execution of ODSS 100 transactions, including data (e.g. code) signing, encryption, or obfuscation. Persons with administrator roles 502 or manager roles 506 administer or manage the transactional users 103T, but do not perform transactions themselves, unless that entity also has a user role 508. Since entities with administrator roles 502 and manager roles 506 must be human users 103H and not machine users 103M, in the discussion that follows, we refer to humans with administrator roles 502 as administrators and humans with manager roles 506 as managers.

An account represents the relation between a company and an ODSS 100 entity and all of the children of the ODSS 100 entity. An account is one of two account types, including an owner account type, and a participant account type. Granting an account provides eligibility to grant permission of a user 103 to access an ODSS entity (and those hierarchically below that entity), but not permission itself. The permission is instead granted to the eligible user 103. A company may have multiple accounts for different ODSS entities, as further discussed below.

The top level ODSS entity (the application platform entity discussed below) can be owned by just one company through an owner account. This is enforced by the ODSS administrator 502 granting an owner account to only one company. However, a company may have a participant account on the two top ODSS entity levels (the application platform entity and the project entity). This structure allows different ODSS entities to be accessible by multiple companies by the granting of the particular type of an account (owner or participant).

Only human users 103H from an owner account can be assigned a manager role 506, and only users 103 whose company has an account (either an owner account or a participant account) can be granted permission to sign data to be installed on devices associated with an entity associated with that account.

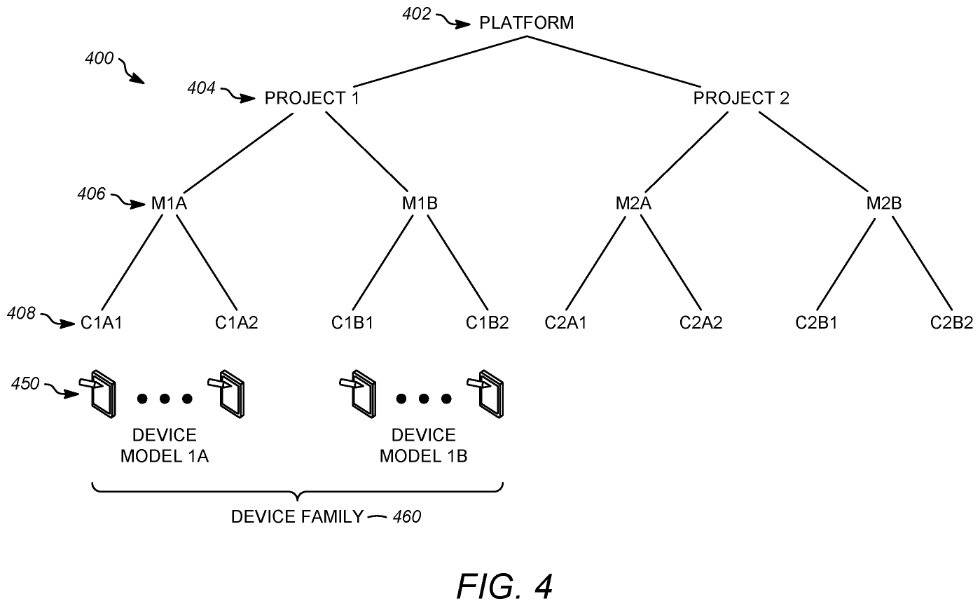

FIG. 4 is a diagram depicting a hierarchical organization (e.g. hierarchy 400) of a plurality of entities associated with data signing operations discussed above. The hierarchy 400 of entities includes, in decreasing hierarchical order, an application platform entity 402, at least one project entity 404 for each application platform entity 402, at least one model entity 406 for each project entity 404 and at least one configuration entity 408 for each model entity.

The application platform entity 402 may be evidenced by a corporate entity that manufactures or produces a plurality of devices 450, such as the assignee of this patent, COMMSCOPE, INC. A platform entity is defined as the highest hierarchical entity that organizes the data signing metadata/information for the fielded devices 450.

The project entity 404 typically comprises a family of devices 460 produced by the application platform entity 402. For example, the corporate entity COMMSCOPE may produce a first family of devices 460 such as set top boxes (STBs) for receiving satellite broadcasts (one project entity) and another family of devices 460 such as STBs for receiving cable broadcasts. Familial or group bounds can be defined as desired, but are typically defined to include products with analogous or similar functional requirements or functional architectures. For example, the project entity may be defined according to the functionality or source of the chip used in the devices 450—for example, those that use one particular digital telecommunication processing chip family belonging to one project and another digital telecommunication processing chip family in another project entity.

The model entity 406 can represent the particular models of the devices 450, for example models of satellite STBs and cable STBs. In the context of data signing, the model designation defines the how the signed data is to be installed on the devices 450 associated with the model entity 406. For example, a particular model of satellite STB may use a different technique for installing new data or code than a different model of the satellite STB. In the context of signing, the configuration entity defines the data to be installed on the devices 450.

For example, the satellite STB of the aforementioned example may include bootloader code (code that executes upon a system reboot that uploads and executes code and scripts), as well as application code. The one configuration entity may represent bootloader code , while a different configuration entity represents the application code.

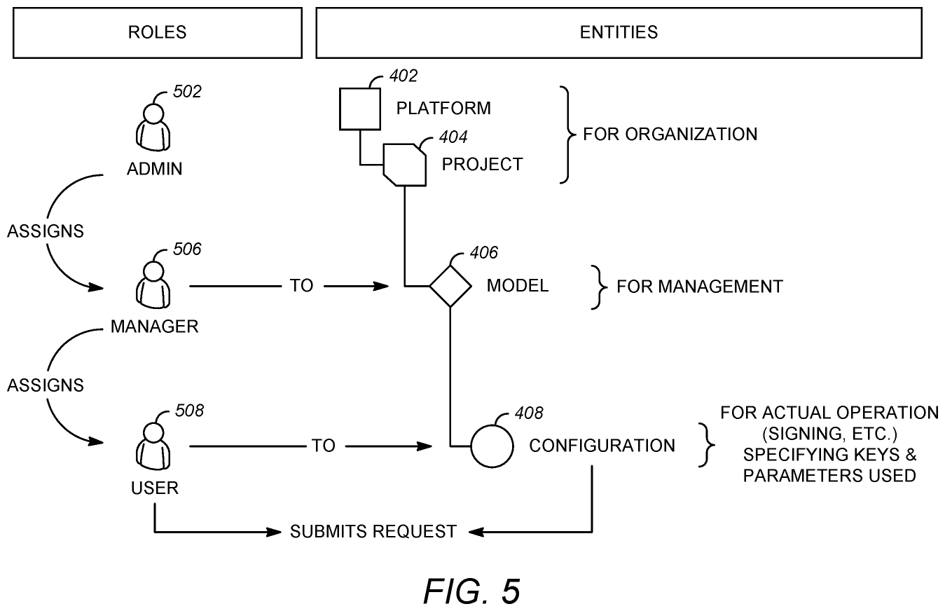

FIG. 5 is a diagram depicting the hierarchy 400 and the roles associated with those entities. The administrator 502 of the ODSS 100 is identified, and that administrator 502 is authorized to define the hierarchy of the entities in decreasing order, an application platform entity 402, at least one project entity 404 for each application platform entity 402, at least one model entity 406 for each project entity 404, and at least one configuration entity 408 for each model entity 406. The administrator 502 is also authorized to access and authorize access to any of the entities 402-408 and may also assign managers 506) to manage a particular model entity 406. This manager 506 is authorized to designate or assign transactional users 103T such as human users 103H or machine users 103M to user roles 508 for a particular configuration entity 408. This transactional user 103T has a user role 508 with respect to an associated configuration entity 408. In some implementations, managers 506 may not add users 103 (this can be accomplished only by the administrator 502), but only authorize users 103 to perform certain roles and grant them permissions to access specific configurations.

The configuration entity 408 holds information regarding the specific data signing operation such as signing keys, signature algorithm, file format, and other security parameters. Managers 506 are normally defined to have access to this configuration information for all the configurations under the manager's managed entity. Transactional users 103T who have access to a configuration entity 408 can use it to perform the data signing activity according to the specified information/parameter but normally do not see the detailed information (e.g. keys, algorithms, and the like) itself.

### Data Signing System Elements

The ODSS 100 has built in data signing operations implemented as “operation types.” Operation types may include proprietary or standard crypto operations such as PKCS#1, PKCS#7. Any cryptographic keys for signing and encryption are preferably protected in the HSM 116 accessible by a Data Signing Engine via an application program interface (API).

Before a user 103 can use the data signing system 100, a “configuration” is defined (typically by an administrator 502 described above). The configuration defines the operation type, the key, and any standard parameters defined by the operation type. For example, the PKCS#1 operation type may require an RSA signing key, and standard parameters may include the Endianness of the operation and what hashing algorithm to use (for example, SHA1 or SHA256).

Once the configuration is defined and authorized to a transactional user 103T, the transactional user 103T can sign data by submitting a request with a pointer to the configuration and the input data image to the system. The data signing engine accepts the configuration parameters and the user uploads input data to be signed, and executes the code implemented for that operation type over the configuration parameters and input image in the request, to create the final output image to return to the client. The transactional user 103T may also encrypt or obfuscate data.

There are different ways to organize signing configurations. One such way is to use a hierarchy structure such as the one illustrated in FIG. 5, discussed above. The configurations are organized in a hierarchy structure starting from Platform 402, followed by project 404, model 406 and then the actual configurations 408. Users 103 of the data signing system may be assigned different roles. In this example, the administrator role 502 is responsible for defining the various entities in the system and assigning a person having a user role 508 as also having a manager role 506 with respect to a model 406. The manager role 506 are responsible for assigning user roles 508 to the actual signing configurations. And finally, transactional users 103T, which can include either human users 103H or machine users 103M can submit signing requests to authorized configurations to perform signing operations.

### Characteristics of ODSS User Types

As described above, ODSS 100 users include human users 103H and machine users 103M. Typically, the fees for data signing services vary according to the user type. For example, the fee for a single human user 103H account that permits data signing is typically less than the fee for a machine user 103M account that also permits data signing. Human user 103H accounts are also typically limited to a single person.

Human users 103H use a browser to access ODSS 100 via a web GUI to sign input data. Typically, such data signing is infrequent, and limited by human actions and response times. Furthermore, signing activities typically align with the human user's work schedule.

On the other hand, machine users 103M use programs or scripts to access the web service interface, and to sign input files. Machine users 103M can perform a large number of signing requests in a short duration, and may have continuous signing activities for a very long time, as is typical with an automated software build process.

Accordingly, the use characteristics of a human user 103H are typically different than those of a machine user 103M.

If the human user's activities manifest behavior far beyond the characteristics of a normal human user 103H, or even close to those of a machine user 103M for a particular duration, such use can be considered to be excessive or unauthorized use or abuse of the human user 103H account. As described above, this can be a security concern (as it may indicate that a hacker is using the data signing service without authorization to prepare code having malware), and can also cause revenue loss, because the charging models for human users 103H and machine users 103M may differ.

One example of abnormal data signing activities is a human user 103H using a configuration and a Public Key Cryptography Standard (PKCS) operation type that is a pure signature of the data. On a typically heavy day, that human user 103H may sign data in a time interval from 3:00 to 22:00 local time which is far beyond a typical human's work hour.

Another example of possible abnormal human user 103H data signing activities is constant large number of daily signing activities with no break on weekends or holidays for an extended period.

Still Another example of possible abnormal data signing activities is a large number of total activities for an extended period comparing with system wide average total activities.

Machine users 103M are also possible sources of aberrant ODSS 100 use. For example, a particular machine user 103M may be permitted a limited number of transactions per time period.

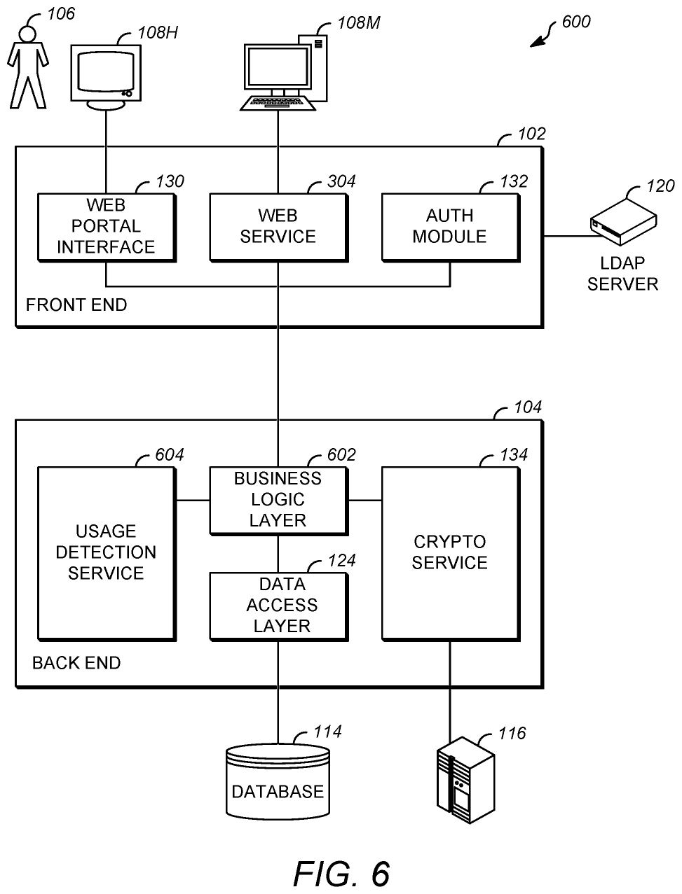

FIG. 6 is a diagram of an ODSS that has been enhanced to scan for usage patterns, identify aberrant usage, and take appropriate actions when such aberrant usage is detected. The enhanced ODSS 600 includes the front end 102, which has a web portal interface 130. The web portal interface 130 provides an interface with human users 103H which may include administrators, managers, and transactional users 103T to perform the operations described herein. Such user operations may include, for example, accepting request from transactional users 103T to begin a session of an account of the ODSS 600, as well as commands to perform an activity of the ODSS 600 such as a data signing transaction.

The enhanced ODSS 600 also comprises the back end 104, communicatively coupled to the ODSS front end 102. The ODSS back end 104 comprises a business logic layer 602, modified to operate with a usage detection service 604. Working with the business logic layer 602 and a crypto service 134, the usage detection service 604 periodically scans user 106?activities stored in the database to generate current user pattern. It then compares the current pattern with past usage pattern if the pattern change is reasonable, otherwise it flag the account as “suspicious” account.

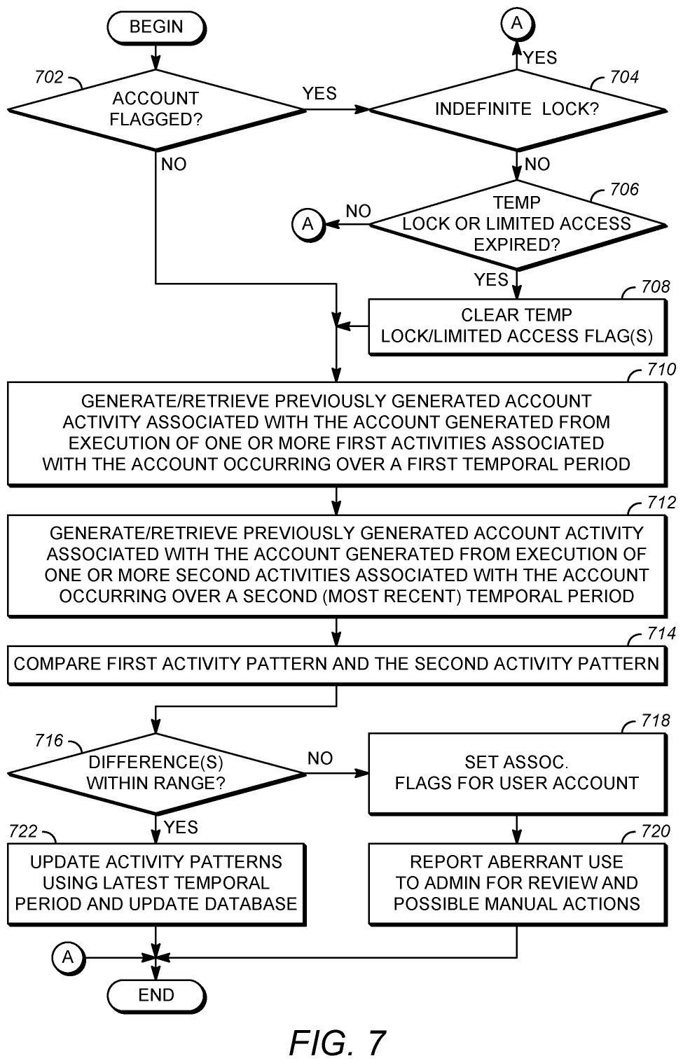

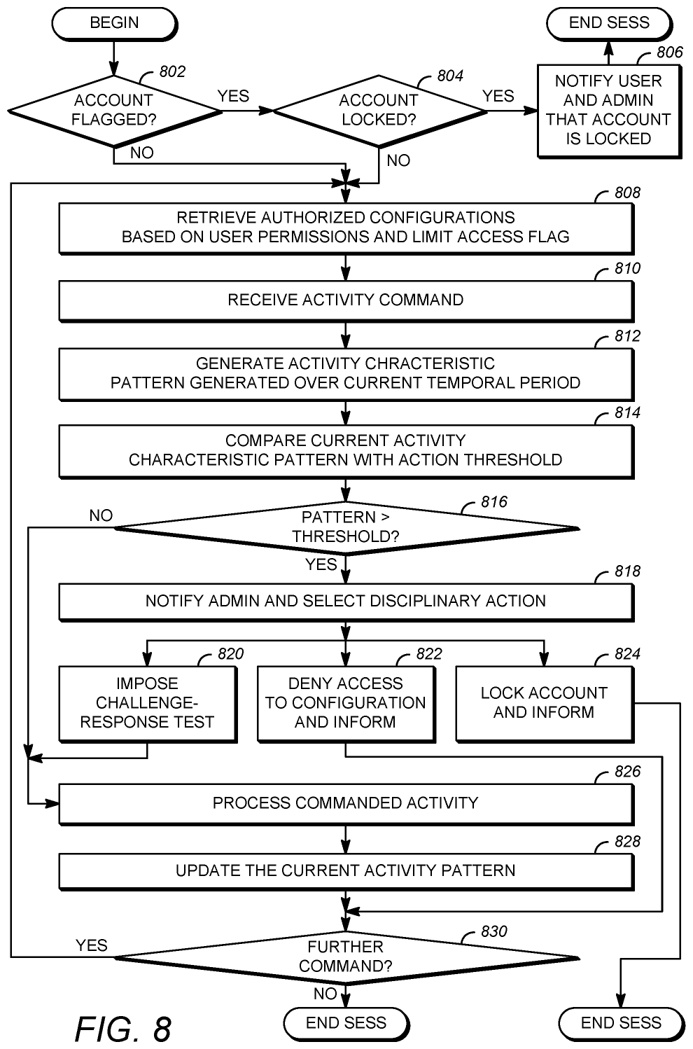

The enhanced ODSS 600 is further discussed connection with FIGS. 7-8, below.

In previous sessions of a user account of the enhanced ODSS, each account activity is logged in a database immediately after the completion of activity. The usage detection service 604 of the enhanced ODSS 600 runs on periodical intervals. Every time the usage detection service 604 runs, it retrieves such logged in activity for an earlier temporal period and retrieves such logged in activity for the most recent temporal period, compares patterns of such activities during the respective periods, and sets one or more flags associated with the account according to that comparison. Such flags may include, for example, an indefinite lock flag that indicates that the account has been indefinitely locked, a temporary lock flag indicating that the account has been temporarily locked (e.g. for a specified period of time) or has been flagged to permit only limited access (for example, access to only a subset of configurations), one or more configuration limit flags (each limiting whether a particular configurations can be accessed and used from the account), and a challenge-response flag.

FIG. 7 is a diagram describing the process of reviewing account activity and setting appropriate flags. The operations shown in FIG. 7 can be performed on a periodic or on demand basis, and permit most of the computations required to enforce limits on accounts to be performed off-line and in advance, so as to not impact system responsiveness when transactional users 103T log in to their account and attempt to perform activities.

In block 702, a check is made to determine if the account has been flagged. If the account has been flagged, processing is routed to block 704 which checks to see if the permanent lock flag has been set. If the permanent lock flag has been set, processing is terminated. The account user 508 may be notified. If the permanent lock flag has not been set, processing is routed to block 706, which determines if the flag is a temporary lock flag or a limited access flag, and determines whether the time for the temporary lock or limited access restriction has expired. If so, processing is routed to block 708 which clears the temporary lock and or limited access flags, and routes processing to block 710. If the temporary lock or limited access restriction has not expired, processing is terminated.

Blocks 710 and 712 generating a first activity pattern and a second activity pattern, respectively, for the account from the database. The first activity pattern has historic data generated from execution of one or more first activities associated with the account over a first temporal period. Typically, this data is generated and is stored in a database for later retrieval to perform the operations of FIG. 7, but the activity pattern itself may be simply generated when needed. The second activity pattern has data generated from execution of one or more second activities associated with the account over a second (most recent) temporal period after the first temporal period. The second activity pattern is typically scheduled to be generated and generated at the end of the second temporal period, but can be generated at any time before comparison with the first activity pattern.

For example, the first activity pattern can be generated from the activity associated with the account for a previous month. Each activity is associated with an activity characteristic, and from the logged activity, an activity pattern of that characteristic is determined. Exemplary instances of activities, activity characteristics, and activity patterns are illustrated in Table I below:

TABLE I

| Activity | Activity Characteristic | Activity Pattern |
|---|---|---|
| Log on | time, user ID, IP address | login time statistic (work |
| | | hours) |
| | | logins/time period (day, |
| | | week, year) |
| Log off | time, user ID, IP address | logout time statistics (work |
| | | hours) |
| | | session duration statistics |
| | | (average, three sigma) |
| | | sessions/time period (day, |
| | | week, year) |
| Transaction | Time | transaction time statistics |
| | Type (sign, encrypt, decrypt, | (transaction frequency or |
| | obfuscate) | transactions/hour, mean |
| | Input (file name, file format, | time between transactions) |
| | file size content hash) | transactions/session (by |
| | Output (file name, file format, | type) |
| | file size, hash of result) | transactions/time period |
| | | (day, week, year) by type |
| | | Input file format statistics |
| | | Output file format statistics |

For example, the enhanced ODSS 600 may keep track of the time at which an assigned human user 103H associated with a particular ID logs in to the service, and at which time the human user 103H logs out of the service. These activity characteristics can be used to generate statistics on the login time, the log out time, the session duration statistics, the number of sessions (login followed by a logout) over a given time period (day, week, month, or year). Login and logout times for machine users 103H can also be monitored and recorded, but are of less value in determining aberrant use.

The statistics regarding past behavior can then be used to identify aberrant behavior that needs further attention or action. For example, if a typical session for a given human user 103H lasted 4 hours and resulted in an average of 20 transactions, the enhanced ODSS 600 may identify a session in which 300 transactions are requested as potential aberrant behavior that needs to be further investigated. Similarly, human user 103H login times can be used to identify aberrant behavior. For example, if a particular assigned human user 103H has never logged in and performed a transaction after ordinary work hours, and then begins to do so with regularity, that activity can be flagged to confirm that the human user 103H has changed their ordinary work hours, is working on a project, or perhaps, that user's account has been compromised or been impermissibly shared with another user. Transaction activity can also be monitored, for example, the time of each activity, the type of the activity (a hash operation, data signing operation, data encryption/decryption operation, or software obfuscation). Statistics regarding the activity (such as the number of transactions per hour or the time between transactions (for example, minimum time between transactions) can be used to identify aberrant behavior. For example, if the minimum time between transactions is a very short value, that would infer that perhaps a user account is being operated by a computer script or program rather than the expected and approved human user 103H). Such statistics can be generated for all transactions generally, or by transaction type, as some transactions may have different temporal conditions than others. The transaction input (file name, format of file, and hash of file content, for example) may also be logged. This can be used to identify which file names and formats are typically used by the particular user 103, so that if different file names or formats are used, the activity can be identified as aberrant. A hash of the input file can also be logged, so that the hash of data used in previous transactions can be compared to the hash of a current activity to determine if the same data is being provided for the operation (e.g. the same code for a code signing operation) for too many times, possibly indicating aberrant behavior or hacking in some cases.

As described further below, if a comparison of past behavior and behavior in the most recent temporal period shows the activities do not align with the user's past activity pattern, the usage detection service 604 sets corresponding flags based on which characteristic does not match. For example, if the session duration (time between log out and log in) in the most recent checking period is substantially different than past activity pattern (enough to exceed the threshold), a flag based on pre-defined action will follow. This may be the case if the session duration is longer than usual (e.g. 12 hours when the virtually all previous sessions lasted no longer than 1 hours), thus indicating that it is not operated by a human being but rather a script or a program. Of course, if the account is associated with a machine user 103M instead of a human user 103H, such use would not be aberrant and a flag would not be set.

In block 714, the first activity pattern and the second activity pattern are compared to identify differences, and block 716 determines if the identified differences are within acceptable values. If the differences exceed acceptable values, the appropriate flags associated with the user account are set and the aberrant use is reported to the administrator for review and possible further action, as shown in blocks 718 and 720. If the differences are within range, block 716 updates the activity patterns using the latest temporal period and updates the database storing these activity patterns.

For example, consider a use case where the first temporal period is one month, beginning on Jun. 1, 2020, and ending on Jun. 30, 2020, and the logged activity is the execution of each transaction, and the activity pattern is the number of transactions per day. Accordingly, if there were 1200 transactions during the first temporal period, there were an average of 40 transactions per day, with a three sigma deviation of 10 transactions per day. 40 transactions per day would be stored as an activity pattern in the database. The second temporal period follows the first temporal period, but need not be the same duration or immediately follow the first temporal period, but should be the most recent temporal period. For example, if today is Jul. 2, 2020, the second temporal period may be one day, and in particular, the previous day, or Jul. 1, 2020. The account activity associated with Jul. 2, 2020, is retrieved (also including logged transactions), and the activity characteristic pattern can be chosen to conform to the metric chosen in for the activity of the first temporal period (e.g. number of transactions per day). Supposing the number of transactions for November 28 was 45, block 716 determines the difference between the two activity patterns (40 transactions per day during the first temporal period and 45 transactions per day during the second temporal period), and determines if the difference 5 transactions per day) is within acceptable limits. If not, block 718 sets the appropriate flags associated with the user account, and block 720 generates an aberrant usage report regarding the user account, and transmits the report to the administrator for review and possible manual actions (including possibly clearing the flags that were set if the administrator believes this is the appropriate action).

If the differences are within acceptable limits, decision block 716 routes processing to block 722, in which the activity patterns are updated using the latest temporal period data. This can be used to implement rolling averages, where the account activity patterns are computed for the a rolling time period. For example, in the use case presented above where the first temporal period ran from Jun. 1, 2020 to Jun. 20, 2020, and the second temporal period was from the beginning to the end of Jul. 2, 2020, block 722 may discard the activity data of Jun. 1, 2020, and add the activity data of Jul. 1, 2020. Alternatively, the activity data from the second temporal period can be simply added to activity data of the first temporal period, resulting in a first temporal period of 31 days with 1245 transactions, resulting in an average of 40.16 transactions per day.

In the foregoing example, the first temporal period was chosen to be longer than the second temporal period so that a larger sample of activities could be assessed to arrive at a more accurate estimate of expected activity. However, this need not be the case, as the first temporal period may be of the same temporal length as the second temporal period, or even shorter. Further, the first temporal period need not be contiguous. For example, if data shows that there is historically more transactions on Monday than on Friday, the first temporal period and the second temporal period may be selected to include only the same day of the week. In this case, the first temporal period may be the each preceding Monday of the month of June (Jun. 1, 2020, Jun. 8, 2020, Jun. 15, 2020, Jun. 22, 2020, and Jun. 29, 2020) and the second temporal period may be selected to be the following Monday or Jul. 6, 2020. The activity characteristic pattern may then be selected to be transactions per Monday. In this case, the operations shown in FIG. 7 may be performed at the end of Jul. 6, 2020, and the appropriate flags set.

Account activity patterns may be represented by statistics (e.g. average number and standard deviation of transactions per day) and the operation of block 716 are a function of those statistics (e.g. determining acceptable ranges from the statistics of the activity of the first temporal period), those acceptable ranges may simply be determined by the administrator 502. The administrator 502 may view the activity characteristic pattern and use the pattern to select the acceptable ranges or may select them on an ad-hoc basis if desired.

FIG. 8 is a diagram illustrating exemplary operations performed when a user 508 logs into their account and attempts to perform a session activity. The enhanced ODSS 600 accepts an account login from the transactional user 103T. The transactional user 103T may be a human user 103H (in which case a username and password is typically needed for the login) or a machine user 103M in which the credentials stored (in a hardware security module) by the machine user 103M are simply provided for login. In decision block 802, the account is checked to determine if it has been flagged, as described in FIG. 7. For a human user 103H, this occurs after the human user 103H logs in, while for a machine user 103M, this test is performed for each requested session.

If the account is flagged, processing is routed to decision block 804 to determine whether the account is locked (e.g. whether the account lock flag has been set). If the account is locked, the transactional user 103T and administrator 502 are informed that the account is locked, and the session is terminated, as shown in block 806. If the account is not flagged or if the account is flagged, but not locked, processing is routed to block 808.

Even if the account has not been flagged by the operations of FIG. 7, for at least some activities, it is desirable to detect and intervene during a user session to prevent aberrant use. This is implemented by blocks 808-830, as further described below.

In the earlier presented example, a use case was postulated for a transactional user 103T that was a human user 103H wherein: (1) the first temporal period is one month, beginning on Jun. 1, 2020 and ending on Jun. 30, 2020, (2) the logged activity included the execution of transactions, and the (3) activity pattern was specified as the number of transactions per day, (4) the second temporal period is Jul. 1, 2020, and at 2 AM of Jul. 2, 2020, the ODSS 600 performed the operations shown in FIG. 7 to determine if any flags needed to be set and it was determined that no flags needed to be set. The morning of Jul. 2, 2020, the transactional user 103T has logged into the ODSS 600, and since the account has not been flagged, processing was routed to blocks 808- 814.

Block 808 retrieves configurations that are authorized for the user account. Such authorized configurations are based on user permissions and whether a limit access flag has been set. In block 810, the ODSS 600 accepts a command to perform a session activity of the security utility, with that session activity to be performed during the currently logged in session of the account. This security utility can include data signing (particularly software), data encryption or obfuscation. For purposes of example, we suppose this session activity is a transaction such as a request to sign code.

In block 812, third account activity pattern is retrieved. The third account activity pattern is generated from execution of one or more third activities associated with the account over a current temporal period. In this example, we assume that the current temporal period is one day and in particular, Jul. 2, 2020. As the transactional user 103T has just logged in and the transaction is the first commanded activity of the day, there is no activity pattern for the current temporal period. Block 814 compares the current activity characteristic pattern with an action threshold. The action threshold is a threshold that defines a limit to account activity characteristic beyond which some action is taken. For example, if the activity characteristic the number of transactions, the action threshold for that activity characteristic may be set for 40 transactions, indicating that any more than 40 transactions will trigger disciplinary action. The action threshold is similar to the acceptable “range” described with respect to FIG. 7 in that they determine whether further action is required. However, instead of setting flags that impact future requests to perform activities, if the third account activity pattern exceeds an action threshold, immediate action is taken. Hence, if the current activity characteristic pattern exceeds the action threshold, block 816 directs processing to block 818, which notifies the administrator 502 that an action threshold has been exceeded, and selects a disciplinary action to be imposed, and routes processing to the appropriate disciplinary action. The action threshold may be pre-configured by the administrator 502, or may be dynamic, as determined by the account activity occurring during the first and second temporal periods and automatically updated thereafter. As further described below, the action threshold may include a challenge response threshold (defining a threshold in activities beyond which a challenge-response test will be imposed on the account of a human user 103H, at least for selected configurations), a configuration limit threshold (defining a threshold in activities beyond which the system will limit the account of the transactional user 103T to a subset of user's authorized data signing configurations), and an indefinite lock threshold (defining a threshold in activities beyond which the account of the transactional user 103T is locked thereafter).

The disciplinary action can be determined based upon the activity that was selected and for which the action threshold has been exceeded, how far in excess the action threshold has been exceeded, or other factors as desired. For example, block 820 imposes a challenge response test on further activities. This disciplinary action may be appropriate, for example, when the activity is still permitted for an account assigned to a human user 103H. To assure that the command was not ultimately from a script rather than a human user 103H, the challenge response test (such as a CAPTCHA) may be imposed. The challenge-response test is required when the activity exceeds a challenge response threshold, and may be indicated by a challenge response flag.

Block 822 denies access to a subset of code signing configurations and informs the user 508 that their account has been so limited. This temporarily suspends user access to the current configuration, it informs transactional user 103T that the current activity cannot be performed until further notice. In one embodiment, the activity on the current configuration is suspended for 24 hours when the daily activity characteristics are reset. This disciplinary action prohibits the transactional user 103T to use the account to perform the commanded activity with the specified configuration, but allows the transactional user 103T to use the account to perform other operations or the same operation for other configurations.

If the account is locked, block 824 routes processing to end the session. If a challenge-response test is imposed and the transactional user 103T (in this case, human user 103H) provides the proper response to the challenge, processing is routed to block 826, which performs the commanded activity. Block 828 updates the current activity pattern to include the permitted activity and routes processing to decision block 830. For example, if the commanded activity was a data signing transaction, the activity pattern for the most recent temporal period is updated to add this to the transaction total for the period.

Block 830 determines whether the transactional user 103T has entered a further activity command. If so, processing is routed to block 808. If not, the session is ended. If the selected disciplinary action is to deny access to the current data signing configuration, block 822 routes processing to block 830, thus skipping blocks 826 and 828. Accordingly, in this case, the commanded activity is not processed and the current activity pattern is not updated.

Other disciplinary actions may be utilized. For example, if the number of transactions exceeds the maximum number of daily transactions, the account of the transactional user 103T and the user account needs to be put on a temporary suspension, the ODSS 600 informs the transactional user 103T in block 824 the current threshold (e.g. maximum daily transactions) is reached and no activity for any configuration will be allowed until next day when the daily activity characteristics are reset.

In one embodiment, each activity characteristic is associated with action threshold values that trigger actions on the part of the enhanced ODSS 600. Action threshold values for each activity characteristic, as well as actions to be taken by the enhanced ODSS 600 when such thresholds are exceeded are configurable by a web-based interface 130 an administrator 502 of the account. Action threshold values are typically determined from the activity pattern of the activity characteristic, and are set to values that indicate aberrant behavior. As such, they may be changed by the administrator 502 to values that minimize false alarms, yet provide useful information. For example, with regard to the login and logout activities discussed above, using the web portal interface 130, the administrator 502 of the account can view the activity pattern and see that the transaction user 103H typically logs in and out at particular times, and set threshold values such that only unexpected variations from those typical times is flagged for threshold values for intervention. In other embodiments, the threshold values may be automatically set by the enhanced ODSS 600 based upon requirements set by the administrator 502 (e.g. to notify or intervene with the values exceed three sigma historical values, or other measure). Some action thresholds can also be configured to certain fixed values by administrator 502 per legal agreement with the organization that the transactional user 103T belongs to.

Another example of an activity and action threshold involves active work hours, as determined from login and logoff activity. In this case login and logout events are activities associated with login time and logout time characteristics, and login, logout, and session time activity characteristic patterns. In this case, an action threshold can be defined for the login activity, the login time activity characteristic, and the login time. If the login activity has a characteristic of a login time a particular human user 103H logged in at a time of day that is outside of the expected range (which can be based on the past user activity pattern) for this particular human user 103H, the enhanced ODSS 600 may put the account on a temporary hold upon discovery, if that is the pre-defined action for this threshold. It may also let the human user 103H continue to use the service but require a challenge response for the rest of day and let the usage detection service 604 flag or suspend the human user 103H at a later point as described in FIG. 7. For example, if the statistics of the login time indicates that the average login time for a human user 103H is 8 AM, ODSS 600 would consider the workhour threshold is exceeded if the human user 103H logged in at 2 AM and has never done so before.

### Hardware Environment

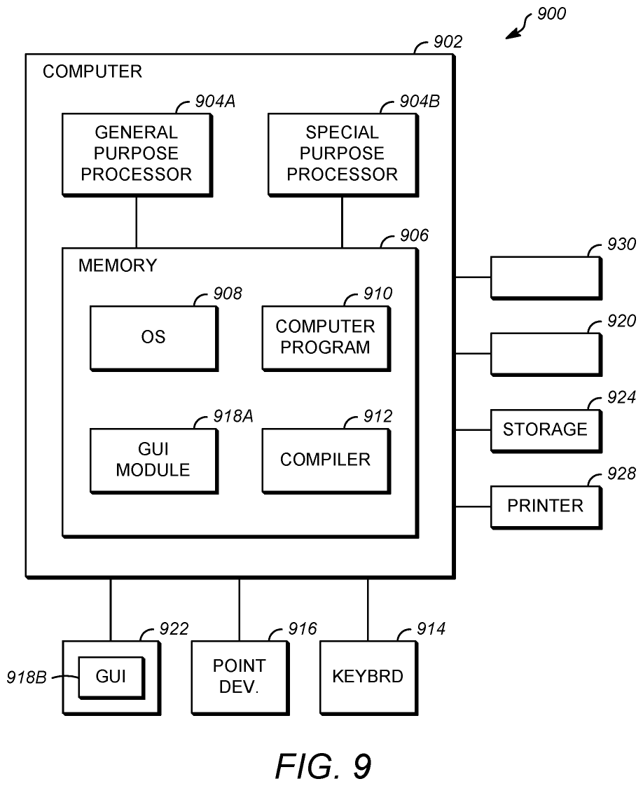

FIG. 9 illustrates an exemplary computer system 900 that could be used to implement processing elements of the above disclosure, including elements of the ODSS front end 102 and ODSS back end 104 of the enhanced ODSS 600, as well as the HSM 116, user authentication service 120. The computer 902 comprises a processor 904 and a memory, such as random access memory (RAM) 906. The computer 902 is operatively coupled to a display 922, which presents images such as windows to the human user 93H on a graphical user interface 918B. The computer 902 may be coupled to other devices, such as a keyboard 914, a mouse device 916, a printer 928, etc. Of course, those skilled in the art will recognize that any combination of the above components, or any number of different components, peripherals, and other devices, may be used with the computer 902.

Generally, the computer 902 operates under control of an operating system 908 stored in the memory 906, and interfaces with the user to accept inputs and commands and to present results through a graphical user interface (GUI) module 918A. Although the GUI module 918B is depicted as a separate module, the instructions performing the GUI functions can be resident or distributed in the operating system 908, the computer program 910, or implemented with special purpose memory and processors. The computer 902 also implements a compiler 912 which allows an application program 910 written in a programming language such as COBOL, C++, FORTRAN, or other language to be translated into processor 904 readable code. After completion, the application 910 accesses and manipulates data stored in the memory 906 of the computer 902 using the relationships and logic that was generated using the compiler 912. The computer 902 also optionally comprises an external communication device such as a modem, satellite link, Ethernet card, or other device for communicating with other computers.

In one embodiment, instructions implementing the operating system 908, the computer program 910, and the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, etc. Further, the operating system 908 and the computer program 910 are comprised of instructions which, when read and executed by the computer 902, causes the computer 902 to perform the operations herein described. Computer program 910 and/or operating instructions may also be tangibly embodied in memory 906 and/or data communications devices 930, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

This document discloses a system and method for detecting and managing aberrant use of a remote data signing utility. In one embodiment, the method comprises generating a first account activity characteristic pattern associated with the account, the first account activity characteristic pattern generated from execution of one or more first activities associated with the account occurring over a first temporal period, generating a second account activity characteristic pattern, the second account activity characteristic pattern generated from execution of one or more second activities associated with the account occurring over a second temporal period, comparing the first account activity characteristic pattern and the second account characteristic activity pattern, and flagging the account for action according to the comparison.

Implementations may include one or more of the following features.

The method above, wherein: flagging the account for action according to the comparison may include: setting one or more flags, the one or more flags may include a lock flag indicating a lock account action; and the method further includes: accepting a login of the account to begin a session; determining if the lock flag is set: if the lock flag is set: terminating the session; if lock flag is not set: accepting a command to perform a session activity of the security utility, the session activity to be performed during the session of the account; retrieving a third account activity characteristic pattern, the third account activity characteristic pattern generated from execution of one or more third activities associated with the account over a current temporal period; comparing the third account activity characteristic pattern with an action threshold; and processing the commanded session activity according to the comparison.

Any combination of the methods above, wherein: the action threshold is configurable by an web-based interface of an administrator of the account.

Any combination of the methods above, wherein: the lock flag may include a temporary lock flag indicating a temporary lock account action or an indefinite lock flag indicating an indefinite lock account action; the action threshold may include a temporary lock action threshold and an indefinite lock action threshold; comparing the third account activity characteristic pattern with an action threshold may include: determining if the third account activity characteristic pattern exceeds the temporary lock action threshold; and determining if the third account activity characteristic pattern exceeds the indefinite lock action threshold; processing the commanded session activity according to the comparison may include: setting the temporary lock flag and ending the session if the third account activity characteristic pattern exceeds the temporary lock action threshold; and setting the indefinite lock flag and ending the session if the third account activity characteristic pattern exceeds the indefinite lock action threshold.

Any combination of the methods above, wherein: the action threshold further may include a configuration limit action threshold and a challenge response action threshold; the one or more flags further may include: a configuration limit flag indicating a limit on configurations available to the account; a challenge response flag indicating that the commanded session activity will be performed only after passing a challenge response test; comparing the third account activity characteristic pattern with an action threshold may include: determining if the third account activity characteristic pattern exceeds the configuration limit action threshold; and determining if the third account activity characteristic pattern exceeds the challenge response action threshold associated with the configuration limit; processing the commanded session activity according to the comparison may include: setting the configuration limit flag if the third account activity characteristic pattern exceeds the configuration limit action threshold; and setting the challenge response flag if the third account activity characteristic pattern exceeds the challenge response action threshold.

Any combination of the methods above, wherein: the first account activity characteristic pattern is generated by: logging each activity associated with the account during the first temporal period in a database of the security utility; and scanning the database for logged activity of the account occurring during the first temporal period; and generating the first account activity characteristic pattern for at least one activity characteristic from the logged activity of the account during the first temporal period; the second account activity characteristic pattern is generated by: logging each activity associated with the account during the second temporal period in the database of the security utility; scanning the database for the logged activity of the account occurring during the second temporal period, the scanning performed on one of: a periodic basis; upon a request to begin a session; and generating the second account activity characteristic pattern for the at least one activity characteristic from the logged activity of the account during the second temporal period.

Any combination of the methods above, wherein: the first temporal period is longer than the second temporal period and precedes the second temporal period; and comparing the first account activity characteristic pattern and the second account characteristic activity pattern may include: comparing the first account activity characteristic pattern and the second account characteristic activity pattern over a matching temporal period.

Any combination of the methods above, wherein: comparing the first account activity characteristic pattern and the second account characteristic activity pattern over the matching temporal period may include: converting at least one of the first account activity characteristic pattern and the second account activity characteristic pattern to the matching temporal period.

Any combination of the methods above, wherein: the first account activity characteristic pattern and the second account activity characteristic pattern are generated for the matching temporal period.

Any combination of the methods above, wherein: the first account activity characteristic pattern and the second account activity characteristic pattern each may include: a number of a type of activity associated with the account.

Any combination of the methods above, wherein: the one or more first activities associated with the account occurring over a first temporal period and the second temporal period and are selected from a group may include: a data signing activity; an encryption activity; and an obfuscation activity. Implementations of the described techniques may include hardware, a method or process, or computer software on a computer-accessible medium.

Another general aspect is evidenced by an apparatus for managing aberrant use of an account of a utility for signing software. The apparatus also includes a processor; a memory, communicatively coupled to the processor, the memory storing processor instructions may include processor instructions for performing any of the above methods.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of managing aberrant use of an account of a utility for signing software, encrypting data, or obfuscating data, the account associated with at least one activity characteristic, the method comprising:
generating a first account activity characteristic pattern associated with the account, the first account activity characteristic pattern generated from execution of one or more first activities associated with the account occurring over a first temporal period;
generating a second account activity characteristic pattern, the second account activity characteristic pattern generated from execution of one or more second activities associated with the account occurring over a second temporal period;
comparing the first account activity characteristic pattern and the second account characteristic activity pattern; and
flagging the account for action according to the comparison.

2. The method of claim 1, wherein:
flagging the account for action according to the comparison comprises:
setting one or more flags, the one or more flags comprising a lock flag indicating a lock account action;
the method further comprises:
accepting a login of the account to begin a session;
determining if the lock flag is set:
if the lock flag is set:
terminating the session;
if lock flag is not set:
accepting a command to perform a session activity of the security utility, the session activity to be performed during the session of the account;
retrieving a third account activity characteristic pattern, the third account activity characteristic pattern generated from execution of one or more third activities associated with the account over a current temporal period; comparing the third account activity characteristic pattern with an action threshold; and processing the commanded session activity according to the comparison. comparing the third account activity characteristic pattern with an processing the commanded session activity according to the

3. The method of claim 2, wherein the action threshold is configurable by an web-based interface of an administrator of the account.

4. The method of claim 2, wherein:
the lock flag comprises a temporary lock flag indicating a temporary lock account action or an indefinite lock flag indicating an indefinite lock account action;
the action threshold comprises a temporary lock action threshold and an indefinite lock action threshold;
comparing the third account activity characteristic pattern with an action threshold comprises:
determining if the third account activity characteristic pattern exceeds the temporary lock action threshold; and
determining if the third account activity characteristic pattern exceeds the indefinite lock action threshold;
processing the commanded session activity according to the comparison comprises:
setting the temporary lock flag and ending the session if the third account activity characteristic pattern exceeds the temporary lock action threshold; and
setting the indefinite lock flag and ending the session if the third account activity characteristic pattern exceeds the indefinite lock action threshold.

5. The method of claim 4, wherein:
the action threshold further comprises a configuration limit action threshold and a challenge response action threshold;
the one or more flags further comprise:
a configuration limit flag indicating a limit on configurations available to the account;
a challenge response flag indicating that the commanded session activity will be performed only after passing a challenge response test;
comparing the third account activity characteristic pattern with an action threshold comprises:
determining if the third account activity characteristic pattern exceeds the configuration limit action threshold; and
determining if the third account activity characteristic pattern exceeds the challenge response action threshold associated with the configuration limit;
processing the commanded session activity according to the comparison comprises:
setting the configuration limit flag if the third account activity characteristic pattern exceeds the configuration limit action threshold; and
setting the challenge response flag if the third account activity characteristic pattern exceeds the challenge response action threshold.

6. The method of claim 1, wherein;
the first account activity characteristic pattern is generated by:
logging each activity associated with the account during the first temporal period in a database of the security utility; and
scanning the database for logged activity of the account occurring during the first temporal period; and
generating the first account activity characteristic pattern for at least one activity characteristic from the logged activity of the account during the first temporal period;
the second account activity characteristic pattern is generated by:
logging each activity associated with the account during the second temporal period in the database of the security utility;
scanning the database for the logged activity of the account occurring during the second temporal period, the scanning performed on one of:
a periodic basis;
upon a request to begin a session; and
generating the second account activity characteristic pattern for the at least one activity characteristic from the logged activity of the account during the second temporal period.

7. The method of claim 6, wherein:
the first temporal period is longer than the second temporal period and precedes the second temporal period; and
comparing the first account activity characteristic pattern and the second account characteristic activity pattern comprises:
comparing the first account activity characteristic pattern and the second account characteristic activity pattern over a matching temporal period.

8. The method of claim 7, wherein:
comparing the first account activity characteristic pattern and the second account characteristic activity pattern over the matching temporal period comprises:
converting at least one of the first account activity characteristic pattern and the second account activity characteristic pattern to the matching temporal period.

9. The method of claim 7, wherein:
the first account activity characteristic pattern and the second account activity characteristic pattern are generated for the matching temporal period.

10. The method of claim 1, wherein the first account activity characteristic pattern and the second account activity characteristic pattern each comprise:
a number of a type of activity associated with the account.

11. The method of claim 1, wherein:
the one or more first activities associated with the account occurring over a first temporal period and the second temporal period and are selected from a group comprising:
a data signing activity;
an encryption activity; and
an obfuscation activity.

12. An apparatus for managing aberrant use of an account of a utility for signing software, encrypting data, or obfuscating data, the account associated with at least one activity characteristic, comprising:
a processor;
a memory, communicatively coupled to the processor, the memory storing processor instructions comprising processor instructions for:
generating a first account activity characteristic pattern associated with the account, the first account activity characteristic pattern generated from execution of one or more first activities associated with the account occurring over a first temporal period;
generating a second account activity characteristic pattern, the second account activity characteristic pattern generated from execution of one or more second activities associated with the account occurring over a second temporal period;
comparing the first account activity characteristic pattern and the second account characteristic activity pattern; and
flagging the account for action according to the comparison.

13. The apparatus of claim 12, wherein:
the processor instructions for flagging the account for action according to the comparison comprises processor instructions for:
setting one or more flags, the one or more flags comprising a lock flag indicating a lock account action;
the processor instructions further comprise processor instructions for:
accepting a login of the account to begin a session;
determining if the lock flag is set:
if the lock flag is set:
terminating the session;
if lock flag is not set:
accepting a command to perform a session activity of the security utility, the session activity to be performed during the session of the account;
generating a third account activity characteristic pattern, the third account activity characteristic pattern generated from execution of one or more third activities associated with the account over a current temporal period;
comparing the third account activity characteristic pattern with an action threshold; and
comparison. processing the commanded session activity according to the

14. The apparatus of claim 13, wherein the action threshold is configurable by an web-based interface of an administrator of the account.

15. The apparatus of claim 13, wherein:
the lock flag comprises a temporary lock flag indicating a temporary lock account action or an indefinite lock flag indicating an indefinite lock account action;
the action threshold comprises a temporary lock action threshold and an indefinite lock action threshold;
the processor instructions for comparing the third account activity characteristic pattern with an action threshold comprise processor instructions for:
determining if the third account activity characteristic pattern exceeds the temporary lock action threshold; and
determining if the third account activity characteristic pattern exceeds the indefinite lock action threshold;
the processor instructions for processing the commanded session activity according to the comparison comprise processor instructions for:
setting the temporary lock flag and ending the session if the third account activity characteristic pattern exceeds the temporary lock action threshold; and
setting the indefinite lock flag and ending the session if the third account activity characteristic pattern exceeds the indefinite lock action threshold.

16. The apparatus of claim 15, wherein:
the action threshold further comprises a configuration limit action threshold and a challenge response action threshold;
the one or more flags further comprise:
a configuration limit flag indicating a limit on configurations available to the account;
a challenge response flag indicating that the commanded session activity will be performed only after passing a challenge response test;
the processor instructions for comparing the third account activity characteristic pattern with an action threshold comprise processor instructions for:
determining if the third account activity characteristic pattern exceeds the configuration limit action threshold; and
determining if the third account activity characteristic pattern exceeds the challenge response action threshold associated with the configuration limit;
the processor instructions for processing the commanded session activity according to the comparison comprise processor instructions for:
setting the configuration limit flag if the third account activity characteristic pattern exceeds the configuration limit action threshold; and
setting the challenge response flag if the third account activity characteristic pattern exceeds the challenge response action threshold.

17. The apparatus of claim 12, wherein;
the first account activity characteristic pattern is generated by:
logging each activity associated with the account during the first temporal period in a database of the security utility; and
scanning the database for logged activity of the account occurring during the first temporal period; and
generating the first account activity characteristic pattern for at least one activity characteristic from the logged activity of the account during the first temporal period;
the second account activity characteristic pattern is generated by:
logging each activity associated with the account during the second temporal period in the database of the security utility;
scanning the database for the logged activity of the account occurring during the second temporal period, the scanning performed on one of:
a periodic basis;
upon a request to begin a session; and
generating the second account activity characteristic pattern for the at least one activity characteristic from the logged activity of the account during the second temporal period.

18. The apparatus of claim 17, wherein:
the first temporal period is longer than the second temporal period and precedes the second temporal period; and
the processor instructions for comparing the first account activity characteristic pattern and the second account characteristic activity pattern comprise processor instructions for:
comparing the first account activity characteristic pattern and the second account characteristic activity pattern over a matching temporal period.

19. The apparatus of claim 18, wherein:
the processor instructions for comparing the first account activity characteristic pattern and the second account characteristic activity pattern over the matching temporal period comprise processor instructions for:
converting at least one of the first account activity characteristic pattern and the second account activity characteristic pattern to the matching temporal period.

20. An apparatus for managing aberrant use of an account of a utility for signing software, encrypting data, or obfuscating data, the account associated with at least one activity characteristic, comprising:
means for generating a first account activity characteristic pattern associated with the account, the first account activity characteristic pattern generated from execution of one or more first activities associated with the account occurring over a first temporal period;
means for generating a second account activity characteristic pattern, the second account activity characteristic pattern generated from execution of one or more second activities associated with the account occurring over a second temporal period;
means for comparing the first account activity characteristic pattern and the second account characteristic activity pattern; and
means for flagging the account for action according to the comparison.
